(19) United States
(12) Patent Application Publication
(10) Pub. No.: US 2008/0165854 A1
(43) Pub. Date: Jul. 10, 2008

(54) METHOD FOR PROCESSING IMAGES

(75) Inventors: Chung-Li Shen, Taipei City (TW); Yu-Chieh Chung, Taipei City (TW); Hung-Lin Kuan, Taipei City (TW)

Correspondence Address: J C PATENTS, INC., 4 VENTURE, SUITE 250, IRVINE, CA, 92618, US

(73) Assignee: BEYOND INNOVATION TECHNOLOGY CO., LTD., Taipei City (TW)

(21) Appl. No.: 11/782,870

(22) Filed: Jul. 25, 2007

(30) Foreign Application Priority Data
Jan. 10, 2007 (TW) 96100887

(51) Int. Cl. H04N 7/12

(52) U.S. Cl. 375/240.16; 375/E07.076

(57) ABSTRACT

An image processing method is provided. According to the present method, the formulas of the prediction modes of a 4*4 block in intra frame prediction are expanded and applied to 4*4 blocks or 8*8 blocks in a 16*16 block. The prediction modes of the 4*4 blocks or 8*8 blocks in the 16*16 block are determined within one pass, or the prediction modes of the 8*8 blocks in the 16*16 block are determined within three passes. Accordingly, the operation of determining the prediction mode of each 4*4 block is saved, and the time for processing intra frame prediction of the 4*4 blocks is effectively reduced. Eventually, the efficiency of image processing is improved.

### CROSS-REFERENCE TO RELATED APPLICATION

This application claims the priority benefit of Taiwan application serial no. 96100887, filed Jan. 10, 2007. All disclosure of the Taiwan application is incorporated herein by reference.

### BACKGROUND OF THE INVENTION

1. Field of the Invention

The present invention generally relates to an image processing method, in particular, to an image processing method which shortens prediction mode determination time and increases image reconstruction speed.

2. Description of Related Art

H.264 is the next-generation video compression standard established by the Joint Video Team (JVT) formed by the Video Coding Expert Group (VCEG) from International Telecommunication Union—Telecommunication Standardization Sector (ITU-T) and the Moving Pictures Experts Group (MPEG) from the International Organization for Standardization (ISO). This technology is also known as the Advanced Video Coding (AVC) after it is brought into MPEG-4 part 10 (ISO/IEC 14496-10), or referred together as H.264/AVC. Related researches show that the H.264/AVC technology provides higher compression ratio and video quality compared to MPEG-2 and MPEG-4 technologies. Thus, the H.264/AVC technology is broadly applied to video conference, video broadcasting, or video streaming services etc.

H.264 has better performance in space and time prediction compared to previous H.263+ standard for it predicts coded blocks using pixels reconstructed through intra frame and inter frame coding. When intra frame prediction is used for predicting the pixel values of a block, the correlation in spatial domain between neighbouring blocks and the current block is used and only the prediction mode and the actual error are recorded in order to increase coding efficiency. Here “neighbouring blocks” usually refers to the blocks above and to the left of the current block, and pixels in these blocks have been coded therefore the information thereof can be reused.

The prediction of a 4*4 block will be described herein as an example. FIG. 1 is a distribution diagram of a 4*4 block in the conventional H.264 standard, wherein a˜p represent pixels in the current block, A˜H represent the marginal pixel values of the blocks above the current block, I˜L represent the marginal pixel values of the block to the left, and the H.264 prediction mode is to predict the pixel values in the current block using these marginal pixel values.

Intra frame prediction technique is divided into 4*4 luma prediction mode, 16*16 luma predication mode, and 8*8 chroma prediction mode according to different image complexities, wherein 4*4 luma prediction mode is further divided into 9 different prediction modes according to different prediction directions. FIG. 2 is a diagram of the 9 prediction modes in 4*4 luma prediction mode in the conventional H.264 standard, and FIG. 3 lists the formulas thereof. Referring to both FIG. 2 and FIG. 3, the 9 prediction modes include a DC mode and 8 other modes in different directions, and according to the positions of the pixels, the formulas of the 9 prediction modes can be summarized as:

$$predictionValue = \{ [ {\sum }_{i} {( coefficient )}_{i} \times {( referrencePixelValue )}_{i} ] + ( Round ) \} / {2}^{shift}$$

wherein i ε Blocks L, K, J, I, M, A, B, C, D, E, F, G, H. For example, if mode 0 (i.e. the vertical mode) is selected, the value of pixel (y, x) at column x and row y can be predicted with following formulas:

pixels (0,0), (1,0), (2,0), and (3,0) are predicted through A;

pixels (0,1), (1,1), (2,1), and (3,1) are predicted through B;

pixels (0,2), (1,2), (2,2), and (3,2) are predicted through C;

pixels (0,3), (1,3), (2,3), and (3,3) are predicted through D.

In addition, if mode 3 (i.e. the diagonal down-left mode) is selected, the pixel values can be predicted with following formulas:

pixel (0,0) is predicted through (A+2B+C+2)/4;

pixels (0,1) and (1,0) are predicted through (B+2C+D+2)/4;

pixels (0,2), (1,1), and (2,0) are predicted through (C+2D+E+2)/4;

pixels (0,3), (1,2), (2,1), and (3,0) are predicted through (D+2E+F+2)/4;

pixels (1,3), (2,2), and (3,1) are predicted through (E+2F+G+2)/4;

pixels (2,3) and (3,2) are predicted through (F+2G+H+2)/4;

pixel (3,3) is predicted through (G+3H+2)/4.

According to 4*4 luma prediction mode, a reference block (predictor) corresponding to a 4*4 sub-block is located using foregoing 9 prediction modes, and a residual image is then obtained by subtracting the 4*4 sub-block and the predictor. Eventually, the residual image is converted based on the selected prediction mode to obtain the image coding of the 4*4 sub-block.

However, according to H.264 standard, an image is actually coded in units of 16*16 blocks, and each 16*16 block is further divided into 4*4 sub-blocks for pixel value prediction. As described above, the reconstructed pixel values of the blocks above or to the left of the current 4*4 sub-block have to be referred to; accordingly, these 4×4 sub-blocks have to be decoded sequentially in a particular order (from top to bottom, left to right). Thus, both resources and time consumed by prediction calculations are relatively increased and the efficiency of image processing cannot be improved even though accurate prediction performance can be achieved.

### SUMMARY OF THE INVENTION

Accordingly, the present invention is directed to an image processing method, wherein the prediction modes of all the 4*4 blocks in a 16*16 block are determined within one pass so that the efficiency of image processing is improved.

The present invention is directed to an image processing method, wherein the prediction modes of all the 8*8 blocks in a 16*16 block are determined within one pass so that the efficiency of image processing is improved.

The present invention provides an image processing method, wherein the prediction modes of all the 8*8 blocks in a 16*16 block are determined one by one so that the efficiency of image processing is improved.

The present invention provides an image processing method suitable for processing an image which can be divided in to a plurality of prediction blocks. The method includes following steps: a. calculating the sums of squared differences between the pixels in the prediction blocks and corresponding marginal pixels under a plurality of prediction modes; b. determining the prediction modes for reconstructing the pixels in the prediction blocks according to the result of step a; and c. reconstructing the pixels in the prediction blocks according to the result of step b.

According to an embodiment of the present invention, the image processing method further includes following steps after step a: a1. calculating the residuals of the pixels in the prediction blocks under the prediction modes using the result of step a; and a2. determining the prediction modes for reconstructing the pixels in the prediction blocks according to the results of steps a and a1.

According to an embodiment of the present invention, the image is a block consisting of 16*16 pixels, and the prediction blocks are 4*4 blocks.

According to an embodiment of the present invention, the image processing method includes vertical prediction mode, horizontal prediction mode, DC prediction mode, diagonal down-left prediction mode, diagonal down-right prediction mode, vertical right prediction mode, horizontal down prediction mode, vertical left prediction mode, and horizontal up prediction mode.

According to an embodiment of the present invention, step a2 further includes: a2-1. determining the corresponding bit rates of the pixels in the prediction blocks under the prediction modes according to the result of step a1; a2-2. calculating the rate-distortion optimizations (RDOs) of the pixels in the prediction blocks according to the results of steps a and a2-1; and a2-3. determining the prediction modes for reconstructing the pixels in the prediction blocks according to the result of step a2-2.

According to an embodiment of the present invention, in step a2-1, the corresponding bit rates of the pixels in the prediction blocks under the prediction modes are determined by performing discrete cosine transform (DCT), quantization, and entropy calculation to the residuals of the pixels in the prediction blocks under the prediction modes.

According to an embodiment of the present invention, the 16 prediction blocks are respectively denoted as prediction blocks a˜p from top to bottom, left to right, and in step c, the prediction blocks are reconstructed in the order of: a→b, e→c, f, i→d, g, j, m→h, k, n→l, o→p.

The present invention provides an image processing method suitable for processing an image which can be divided into a plurality of prediction blocks. The method includes following steps: a. dividing the prediction blocks into a plurality of domains, wherein each domain has at least two of the prediction blocks; b. calculating the sums of squared differences between pixels in the prediction blocks and the corresponding marginal pixels under a plurality of prediction modes in one of the domains; c. determining the prediction modes for reconstructing the pixels in the prediction blocks in the domain according to the result of step b; d. reconstructing the pixels in the prediction blocks in the domain according to the result of step c; and e. reconstructing the pixels in the prediction blocks in a neighbouring domain using the reconstructed marginal pixels in the current domain according to the result of step d.

According to an embodiment of the present invention, the image processing method further includes following steps after step b: b1. calculating the residuals of the pixels in the prediction blocks in the domain under the predication modes using the result of step b; and b2. determining the prediction modes for reconstructing the pixels in the prediction blocks in the domain according to the results of steps b and b1.

According to an embodiment of the present invention, the image is a block consisting of 16*16 pixels, the prediction blocks are 4*4 blocks, and the domains are 8*8 blocks.

According to an embodiment of the present invention, step b2 further includes: b2-1. determining the corresponding bit rates of the pixels in the prediction blocks in the domain under the prediction modes according to the result of step b1; b2-2. calculating the RDOs of the pixels in the prediction blocks in the domain according to the results of steps b and b2-1; and b2-3. determining the prediction modes for reconstructing the pixels in the prediction blocks in the domain according to the result of step b2-2.

According to an embodiment of the present invention, the four prediction blocks are respectively denoted as prediction blocks a, b, e, and f from top to bottom, left to right, and in step e, the prediction blocks are reconstructed in the order of: a→b, e→f.

According to an embodiment of the present invention, step e further includes: e1. calculating the sums of squared differences between the pixels in the prediction blocks in at least one neighbouring domain and the corresponding reconstructed marginal pixels under the plurality of prediction modes; e2. calculating the residuals of the pixels in the prediction blocks in the neighbouring domain under the prediction modes using the result of step e1; e3. determining the prediction modes for reconstructing the pixels in the prediction blocks in the neighbouring domain according to the results of steps e1 and e2; and e4. reconstructing the pixels in the prediction blocks in the neighbouring domain according to the result of step e3. In addition, foregoing steps e1˜e4 are for reconstructing the pixels in two neighbouring domains.

The present invention provides an image processing method suitable for processing an image which can be divided into a plurality of prediction blocks. The method includes following steps: a. dividing the prediction blocks into a plurality of domains, wherein each domain has at least two of the prediction blocks; b. calculating the sums of squared differences between the pixels in the prediction block in each domain and the corresponding marginal pixels under a plurality of prediction modes; c. determining the prediction modes for reconstructing the pixels in the prediction blocks in each domain according to the result of step b; and d. reconstructing the pixels of the prediction blocks in each domain according to the result of step c.

According to an embodiment of the present invention, the image processing method further includes following steps after step b: b1. calculating the residuals of the pixels in the prediction blocks in each domain under the prediction modes according to the result of step b; and b2. determining the prediction modes for reconstructing the pixels in the prediction blocks in each domain according to the results of steps b and b1.

According to an embodiment of the present invention, the image is a block consisting of 16*16 pixels, the prediction blocks are 4*4 blocks, and the domains are 8*8 blocks.

According to an embodiment of the present invention, step b2 further includes: b2-1. determining the corresponding bit rates of the pixels in the prediction blocks in each domain under the prediction modes according to the result of step b-1; b2-2. calculating the RDOs of the pixels in the prediction blocks in each domain according to the results of steps b and b2-1; and b2-3. determining the prediction modes for reconstructing the pixels in the prediction blocks in each domain according to the result of step b2-2.

According to an embodiment of the present invention, the four domains are respectively denoted as domains I, II, III, and IV from top to bottom, left to right, and in step e, the prediction blocks are reconstructed in the order of: I→II, III→IV.

In the present invention, the formulas of prediction modes for a 4*4 block are expanded and applied to 4*4 blocks or 8*8 blocks in a 16*16 block, thus, the time and resources for determining the prediction modes of the 4*4 blocks are reduced, and accordingly, the efficiency of image processing is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a distribution diagram of a 4*4 block according to conventional H.264 standard.

FIG. 2 is a diagram illustrating the 9 prediction modes in 4*4 luma prediction mode according to conventional H.264 standard.

FIG. 3 lists the formulas of the 9 prediction modes in 4*4 luma prediction mode according to conventional H.264 standard.

FIG. 4 is a flowchart illustrating an image processing method according to a first embodiment of the present invention.

FIG. 5 is a diagram of a prediction mode 3 of H.264 intra frame algorithm according to the first embodiment of the present invention.

FIG. 6 is a flowchart illustrating a difference square sum calculation method according to the first embodiment of the present invention.

FIG. 7 illustrates the difference square sums in 9 different prediction modes according to the first embodiment of the present invention.

FIG. 8 illustrates an example of the image processing method according to the first embodiment of the present invention.

FIG. 9 illustrates an example of pixel reconstruction according to the first embodiment of the present invention.

FIG. 10 is a flowchart illustrating an image processing method according to a second embodiment of the present invention.

FIG. 11 illustrates the difference square sums in 9 different prediction modes according to the second embodiment of the present invention.

FIG. 12 illustrates an example of an image processing method according to the second embodiment of the present invention.

FIG. 13 is a flowchart illustrating an image processing method according to a third embodiment of the present invention.

FIG. 14 illustrates the difference square sums in 9 different prediction modes according to the third embodiment of the present invention.

FIG. 15 is a diagram illustrating an image processing method according to the third embodiment of the present invention.

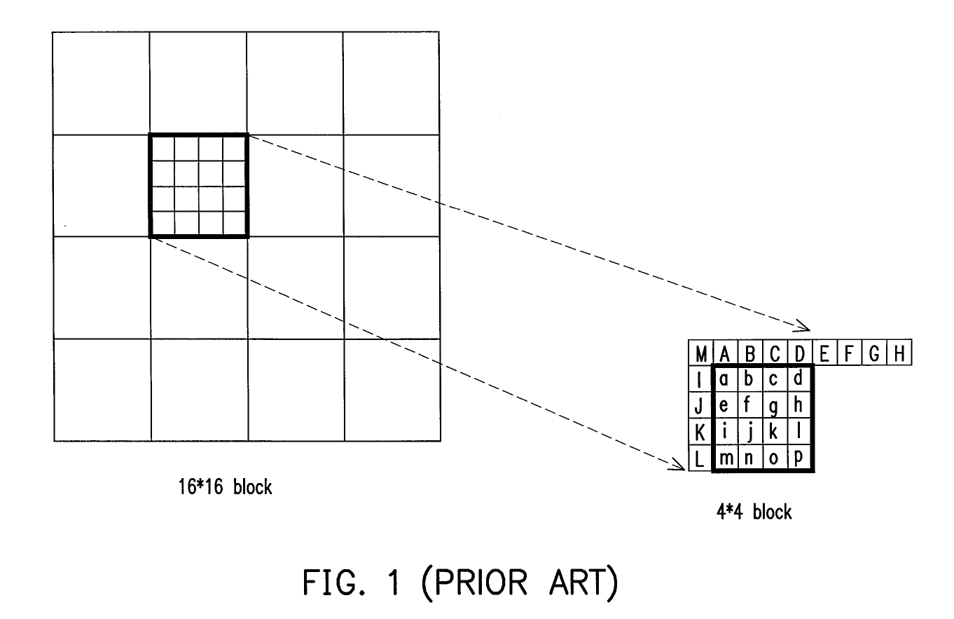

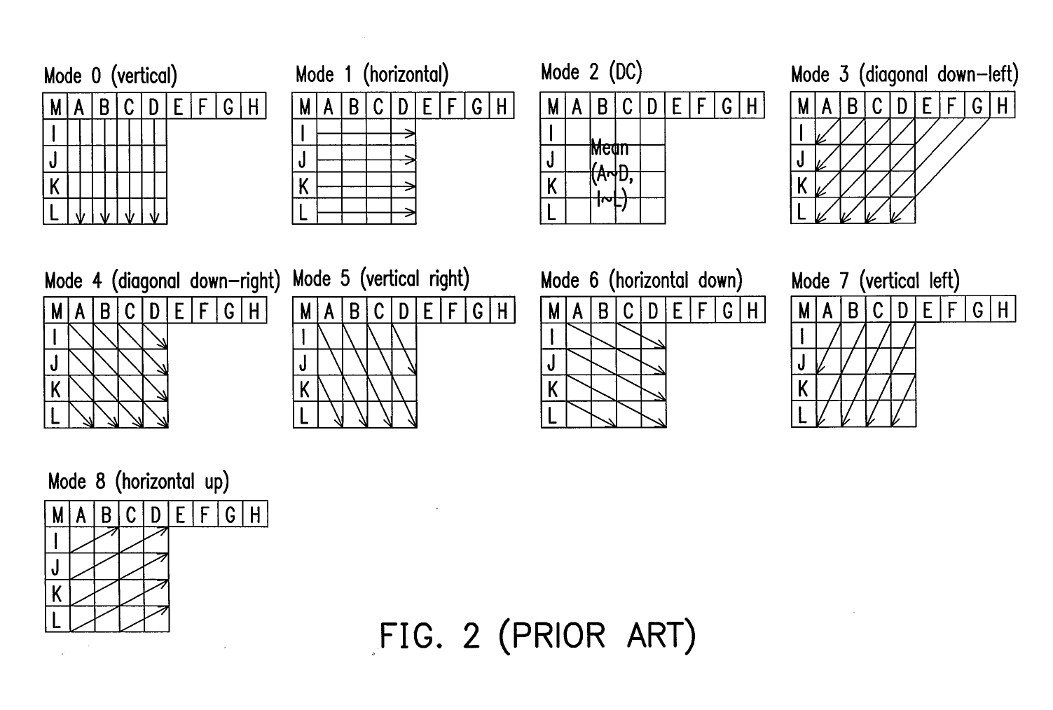

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In image intra frame prediction, the marginal pixels in the blocks above or to the left to the current block have to be referred to in order to calculate the prediction values of the pixels in the current block and determine a most suitable prediction mode for reconstructing the pixels in the current block. Accordingly, the blocks in an image have to be processed one by one according to the image prediction algorithm. To resolve this problem, in the present invention, the original prediction formulas for a small block are expanded and applied to a big block so that the prediction modes suitable for small blocks or for domains containing several small blocks in the big block can be determined within one pass. By calculating the marginal pixels of each block in advance, the prediction values of the pixels in multiple blocks can be calculated at the same time, and accordingly, the efficiency of image processing can be improved. Embodiments of the present invention will be described below with reference to accompanying drawings.

### The First Embodiment

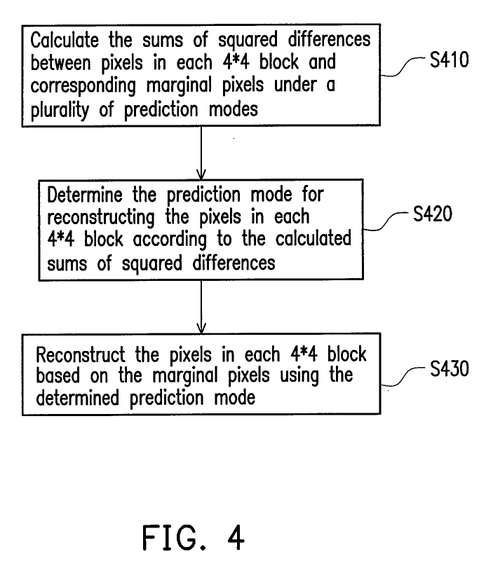

FIG. 4 is a flowchart illustrating an image processing method according to the first embodiment of the present invention. Referring to FIG. 4, this method is suitable for processing an image which can be divided into a plurality of 4*4 blocks. A 16*16 block in the image includes sixteen 4*4 blocks, and each of the 4*4 blocks includes 16 pixels. In the present embodiment, the original prediction formulas for a 4*4 block are expanded and applied to a 16*16 block so that the prediction modes of the 4*4 blocks in the 16*16 block can be determined within one pass and accordingly the efficiency of image processing can be improved.

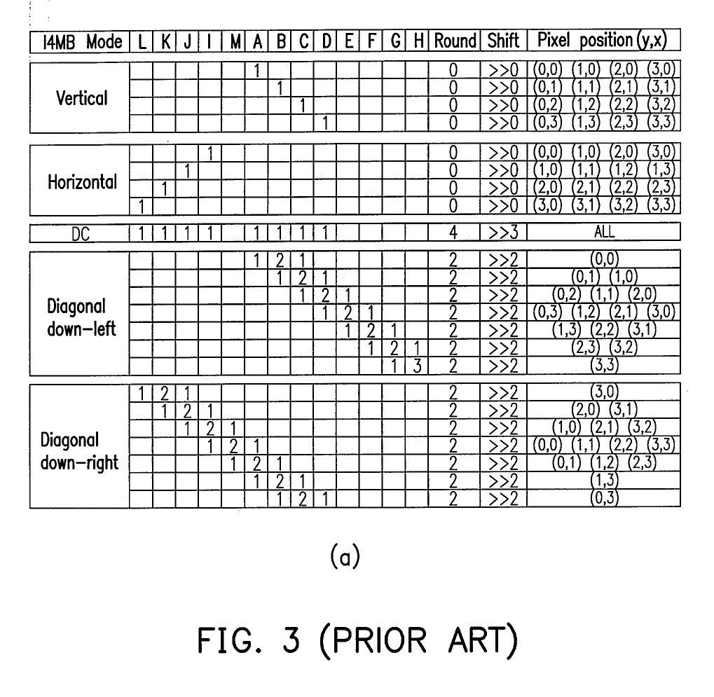

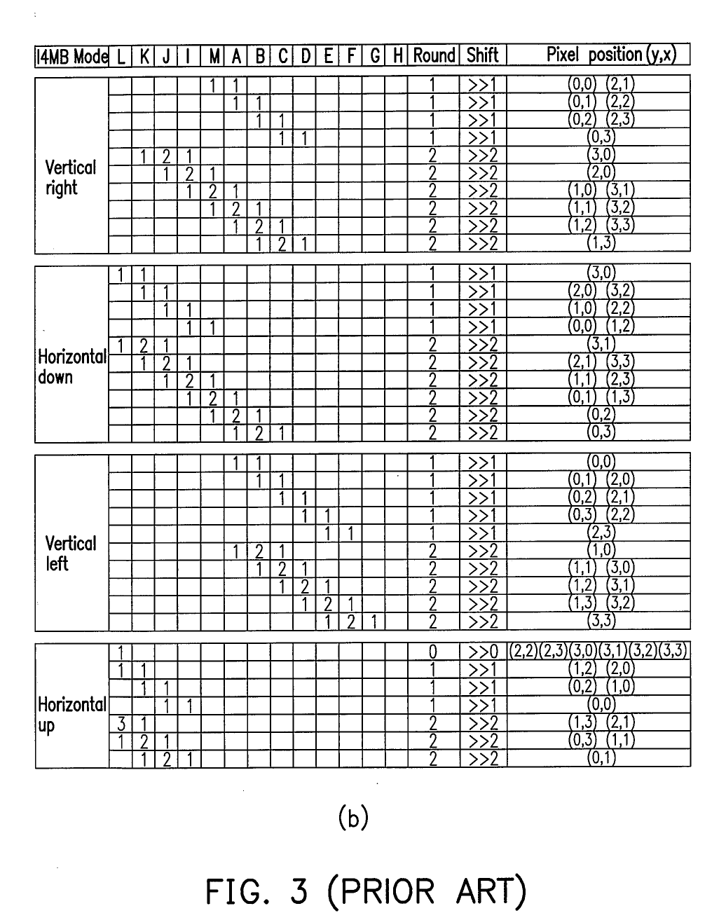

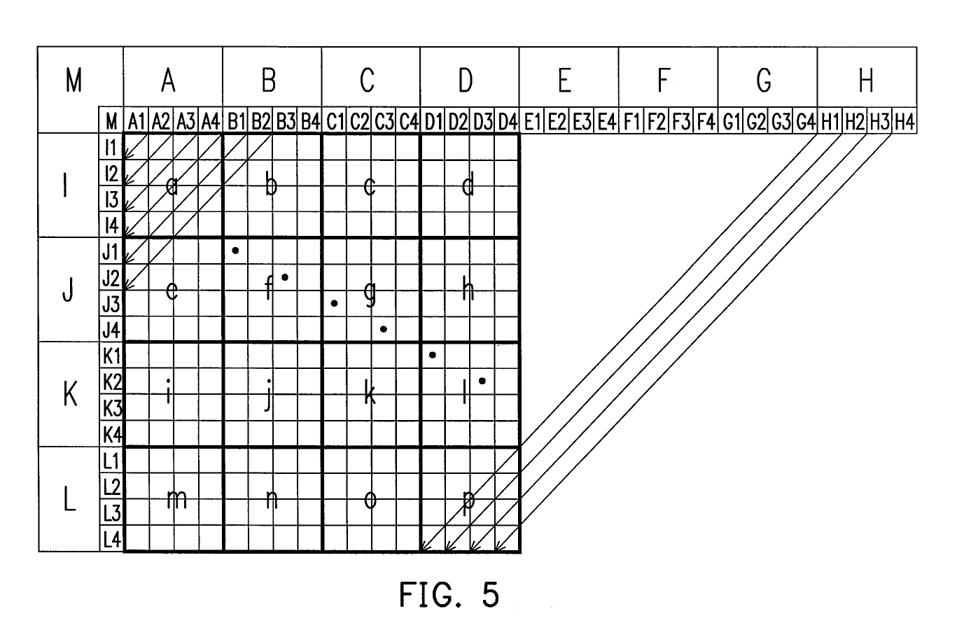

To be specific, the original 9 prediction modes (as shown in FIG. 2 and FIG. 3) of intra frame prediction algorithm are expanded and applied to 16*16 blocks. FIG. 5 illustrates the prediction mode 3 (i.e. the diagonal down-left mode) in intra frame prediction algorithm according to the first embodiment of the present invention. Referring to both FIG. 2 and FIG. 5, similar to the conventional prediction mode 3, all the reference pixels in the prediction mode 3 of the present embodiment point 45° towards bottom left. The only difference of the present embodiment from the prior art is that the original prediction formulas for 4*4 blocks are expanded and applied to 16*16 blocks. For example, in the present embodiment, pixel (0,0) is predicted through formula (A1+2A2+A3+2)/4, pixels (0,1) and (1,0) are predicted through formula (A2+2A3+A4+2)/4, pixels (0,2), (1,1), and (2,0) are predicted through formula (A3+2A4+B1+2)/4, and so on.

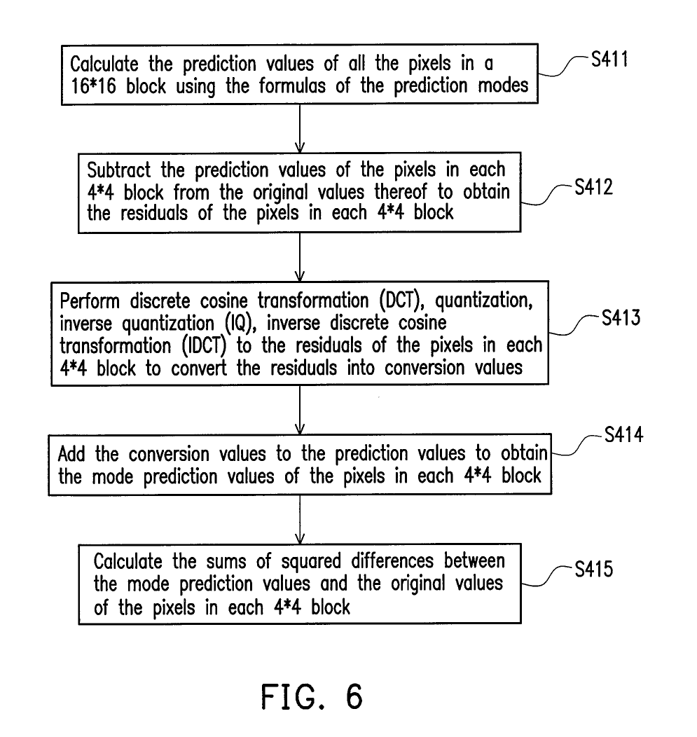

In the present embodiment, formulas of the 9 prediction modes are expanded as described above, and the sums of square differences between the pixels in the 4*4 blocks and the corresponding marginal pixels in various prediction modes are calculated (step S410), wherein the marginal pixels may be the pixels of a column/row matrix. In addition, foregoing step may be further divided into a plurality of steps. FIG. 6 is a flowchart illustrating a method for calculating the sums of squared differences according to the first embodiment of the present invention. Referring to FIG. 6, first, the prediction values of all the pixels in a 16*16 block corresponding to the 9 prediction modes are calculated using foregoing prediction formulas (step S411).

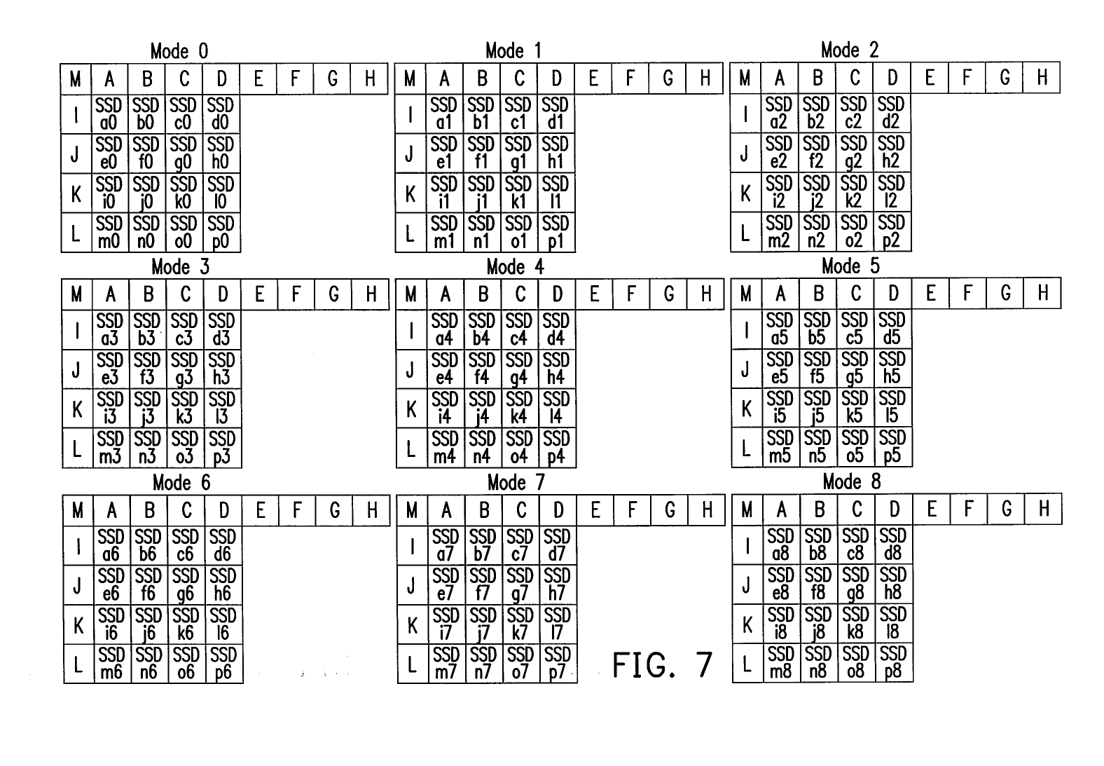

Next, the prediction values of the pixels in each 4*4 block are subtracted from the original values thereof to obtain the residuals of the pixels in each 4*4 block (step S412). These residuals are then converted into conversion values through discrete cosine transformation (DCT), quantization (Q), inverse quantization (IQ), and inverse discrete cosine transformation (IDCT) (step S413). The prediction values are added to the conversion values to obtain the mode prediction values (step S414). Finally, the sums of squared differences between the mode prediction values of the pixels in each 4*4 block and the original values thereof are calculated to obtain the sums of squared differences under the 9 different prediction modes as illustrated in FIG. 7 (step S415), and the formula for calculating the sums of squared differences is as following:

$$SumOfSquaredDifferences = {\sum }_{i = 0}^{x - 1} {\sum }_{j = 0}^{y - 1} {[ {( ModePredictionValue )}_{i , j} - {( OriginalValue )}_{i , j} ]}^{2}$$

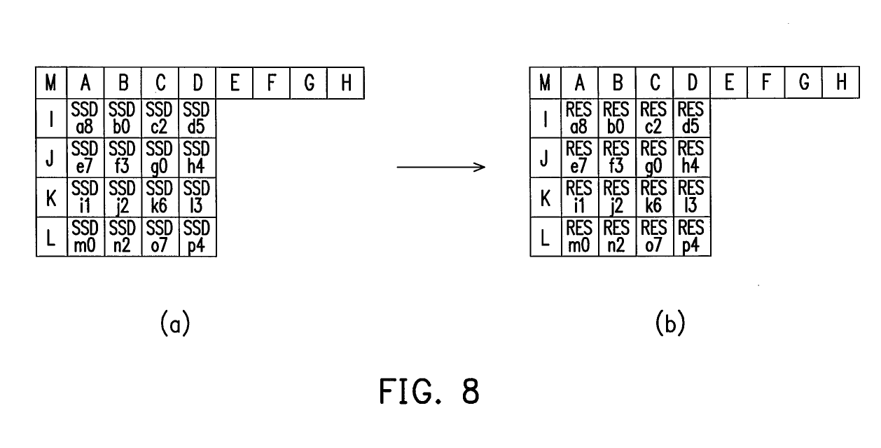

, wherein x represents the row number of a block, and y represents the column number of the block. The most suitable prediction mode for each of the 4*4 blocks can be determined according to the sums of squared differences under various prediction modes (step S420). To be specific, in the present embodiment, regarding each 4*4 block, the smallest value among the 9 sums of squared differences under the 9 prediction modes is selected, and the prediction mode having the smallest value is selected as the most suitable prediction mode for this 4*4 block. FIG. 8 illustrates an example of the image processing method according to the first embodiment of the present invention. Referring to FIG. 8(a), the prediction mode selected for block a is the 8^{th} prediction mode, the prediction mode selected for block b is the 0^{th} prediction mode, and so on. Forgoing steps are all completed within one pass, thus, the processing time for determining the prediction modes of the blocks is reduced.

It should be mentioned here that a simple pattern of the intra frame prediction algorithm is adopted in foregoing prediction mode determination process. However, the factor of bit rate has to be considered if a complex pattern of the intra frame prediction algorithm is adopted. The bit rates of pixels in the 4*4 blocks corresponding to various prediction modes can be obtained by calculating the residuals of the pixels in the 4*4 blocks under various prediction modes (as shown in FIG. 8(b)) and then performing discrete cosine transform (DCT), quantization, and entropy calculation to the residuals. Next, the bit rates are added to the original sums of squared differences to obtain the rate-distortion optimizations (RDOs) of the pixels in the 4*4 blocks. Accordingly, the prediction modes corresponding to the smallest RDOs are respectively selected as the prediction modes for reconstructing the pixels in the 4*4 blocks. The prediction modes obtained herein are more accurate than the prediction modes obtained in foregoing example for the factor of bit rate is considered.

Thereafter, the pixels in the 4*4 blocks are reconstructed based on the marginal pixels of the image by using these selected prediction modes in another pass (step S430). The reconstruction of all the pixels in the 16*16 block is completed once the reconstruction values of the pixels in all the 4*4 blocks in the 16*16 block have been obtained. In the present embodiment, the 16*16 block is divided into sixteen 4*4 blocks which are respectively denoted as blocks a˜p from top to bottom, left to right (as shown in FIG. 5), and these 4*4 blocks are reconstructed in the order of: a→b, e→c, f, i→d, g, j, m→h, k, n→l, o→p.

In the present embodiment, to increase the speed of foregoing pixel reconstruction process, the marginal pixels of a 4*4 block are calculated first using the prediction formulas and these marginal pixels are further provided for the prediction of a neighboring 4*4 block. Accordingly, the neighbouring 4*4 block can be reconstructed at the same time while the current 4*4 block is being reconstructed so that the time required for pixel reconstruction is greatly reduced.

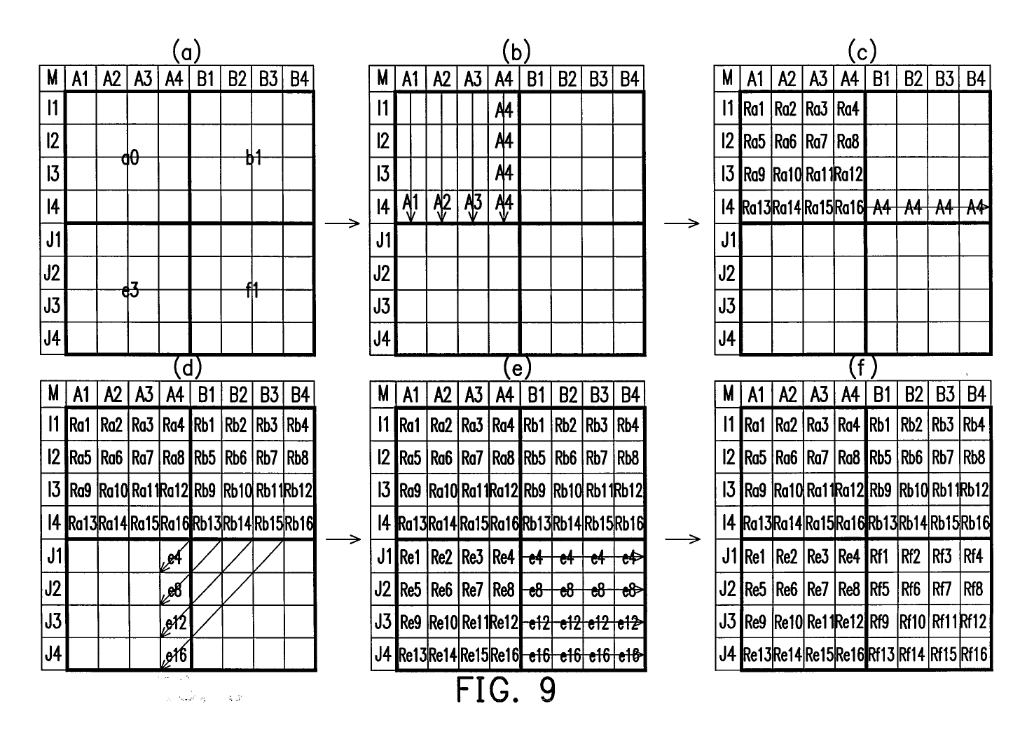

An embodiment of the present invention will be described below in details so that foregoing pixel reconstruction process can be understood better. For the convenience of description, the pixel reconstruction of only four 4*4 blocks a, b, e, and f (the top left four 4*4 blocks in FIG. 5) will be described herein demonstratively. FIG. 9 illustrates an example of pixel reconstruction according to the first embodiment of the present invention. Referring to FIG. 9, in the present embodiment, the prediction values of the pixels in the 4*4 block a in FIG. 9(a) are first calculated using the prediction formulas of the prediction mode corresponding to the 4*4 block a, and the prediction values are added to the residuals of the pixels in the 4*4 block a obtained in step S412 to obtain the reconstruction values of the pixels in the 4*4 block a.

It should be mentioned here that in foregoing steps, the prediction values of the 7 pixels at the right edge and lower edge of the 4*4 block a can be calculated first using the prediction formulas and provided to the 4*4 blocks b and e under and to the right of the 4*4 block a, so that the reconstruction works of the 4*4 blocks b and e can be started earlier. Accordingly, the time waiting for the 4*4 block a to be reconstructed can be saved and the reconstruction speed of the entire image can be increased. For example, as shown in FIG. 9(b), the prediction mode of the 4*4 block a is the vertical down prediction mode, thus, the prediction values of the pixels at the lower and right edges of the 4*4 block a can be calculated first.

After that, the prediction values of the pixels in the 4*4 blocks b and e can be further calculated and added to the residuals thereof to obtain the reconstruction values of the pixels in the 4*4 blocks b and e. The pixels at the lower edge of the 4*4 block b may be used for calculating the prediction values of the pixels in the 4*4 block e, thus, in foregoing step, the prediction values of the four pixels at the lower edge of the 4*4 block b are first calculated using the prediction formulas and provided to the 4*4 block e, so that the reconstruction work of the 4*4 block e can be started earlier. Accordingly, the time for waiting the 4*4 block b to be reconstructed can be saved and the reconstruction speed of the entire image can be increased.

For example, as shown in FIG. 9(c), the prediction mode of the 4*4 block b is horizontal right prediction mode, thus, the prediction values of the pixels at the lower edge of the 4*4 block b are calculated first, and at the same time, the reconstruction values Ra1˜Ra16 of the pixels in the 4*4 block a are calculated. After the prediction values of the pixels at the lower edge of the 4*4 block b are obtained, these prediction values are used for calculating the prediction values of the pixels in the 4*4 block e, and to be able to calculate the prediction values of the pixels in the 4*4 block f earlier, the prediction values of the pixels at the right edge of the 4*4 block e are calculated first. For example, as shown in FIG. 9(d), the prediction mode of the 4*4 block e is vertical down-left prediction mode, thus, the prediction values of the pixels at the right edge of the 4*4 block e are calculated using the pixels at the lower edge of the 4*4 block b, and the prediction values e4, e8, e12, and e16 are then obtained. The formulas for calculating these prediction values are as shown in FIG. 3 and will not be described herein. The reconstruction values Rb1˜Rb16 of the pixels in the 4*4 block b may also be calculated while calculating these prediction values.

After obtaining the prediction values of the pixels at the lower edge of the 4*4 block b and the pixels at the right edge of the 4*4 block e, the prediction values of the pixels in the 4*4 block f are further calculated and added to the residuals thereof to obtain the reconstruction values of the pixels in the 4*4 block f. As shown in FIG. 9(e), the prediction mode of the 4*4 block f is horizontal right prediction mode; thus, the prediction values of the pixels in the 4*4 block f can be calculated using the prediction values of the pixels at the right edge of the 4*4 block e. The reconstruction values Re1˜Re16 of the pixels in the 4*4 block e are calculated at the same time while the prediction values of the pixels in the 4*4 block f are being calculated. Finally, as shown in FIG. 9(f), the prediction values of the pixels in the 4*4 block f are added to the residuals thereof to obtain the reconstruction values Rf1˜Rf16 of the pixels in the 4*4 block f.

In the present embodiment, the prediction modes of all the 4*4 blocks in a 16*16 are determined within one pass, which simplifies the original calculations over sixteen 4*4 blocks under the 9 prediction modes to calculations over only one 16*16 block under the 9 prediction modes and reduces the processing time of intra frame prediction of the 4*4 blocks, thus, the efficiency of image processing is improved.

### The Second Embodiment

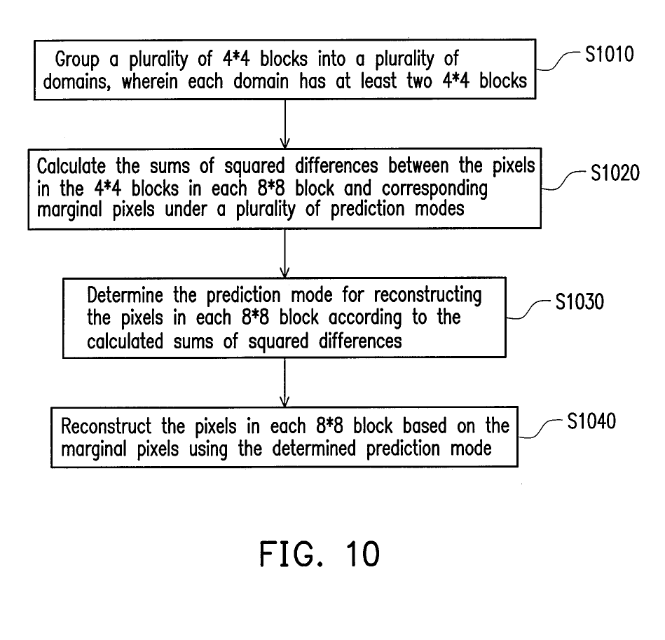

FIG. 10 is a flowchart illustrating an image processing method according to the second embodiment of the present invention. Referring to FIG. 10, the method in the present embodiment is suitable for processing an image which can be divided into a plurality of 4*4 blocks. First, these 4*4 blocks are grouped into a plurality of (for example, 4) domains, wherein each domain has at least two of the 4*4 blocks (step S1010). Domains consisting of four 4*4 blocks (i.e. 8*8 blocks) will be described below as an example. In other words, a 16*16 block includes four 8*8 blocks, each 8*8 block includes four 4*4 blocks, and each 4*4 block includes 16 pixels. In the present embodiment, the original prediction formulas for a 4*4 block are expanded and applied to a 16*16 block, and the prediction modes of all the 8*8 blocks in the 16*16 block are determined within one pass, therefore the efficiency of image processing is improved.

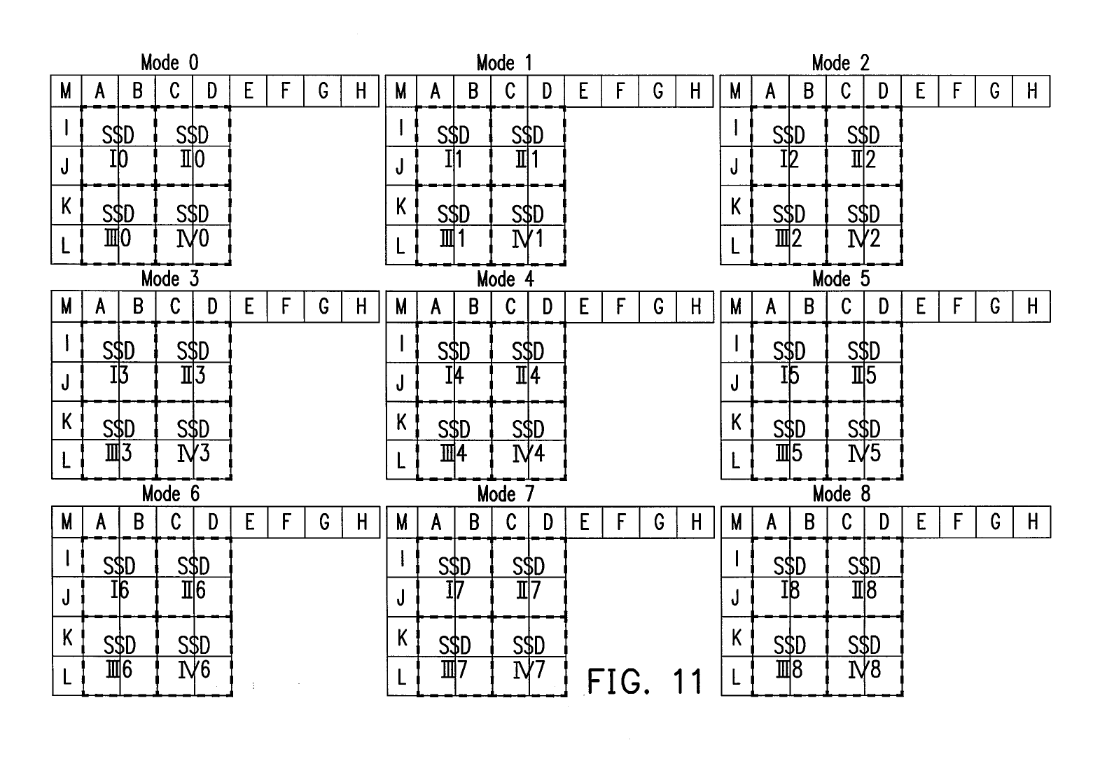

Similar to the first embodiment, the sums of squared differences between the pixels in the 4*4 blocks and the corresponding marginal pixels in each 8*8 block under a plurality of prediction modes are calculated first in the present embodiment (step S1020). The formula for calculating the sums of squared differences is similar to that in the first embodiment, therefore will not be described herein. The only difference between the two is that in the present embodiment, the calculation is based on 8*8 blocks, wherein the sums of squared differences between the mode prediction values of the pixels in each 8*8 block and the original values thereof under the 9 different prediction modes are calculated, as shown in FIG. 11.

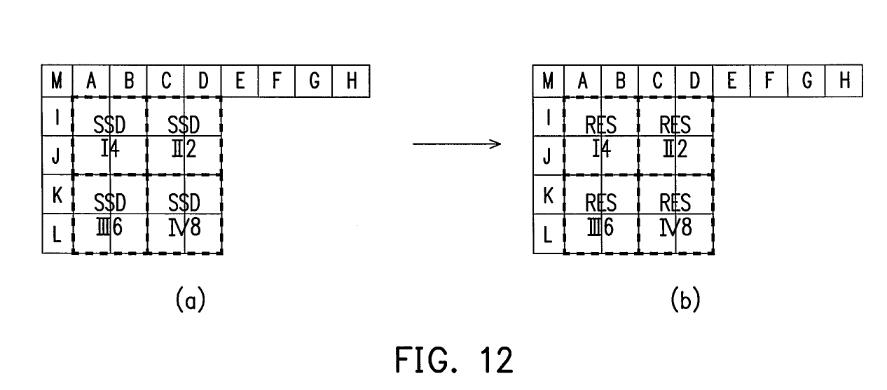

The most suitable prediction modes for the 8*8 blocks are then determined according to the sums of squared differences under the 9 prediction modes (step S1030). To be specific, in the present embodiment, the smallest value among the 9 sums of squared differences calculated under the 9 prediction modes is selected regarding each 8*8 block, and the prediction mode having the smallest value is selected as the most suitable prediction mode for this 8*8 block. FIG. 12 illustrates an example of the image processing method according to the second embodiment of the present invention. As shown in FIG. 12(a), the prediction mode selected for block I is the 4^{th} prediction mode, the prediction mode selected for block II is the 2^{nd} prediction mode, and so on. Foregoing steps are all completed within one pass, therefore the processing time for determining the prediction modes of the blocks is reduced.

Similarly, the factor of bit rate may also be considered in the present embodiment. The bit rates corresponding to various prediction modes of each 8*8 block can be obtained by calculating the residuals of the pixels in the 8*8 block under the prediction modes (as shown in FIG. 12(b)) and performing DCT, quantization, and entropy calculation to the residuals. Next, the bit rates are added to the original sums of squared differences to obtain the RDOs of the pixels in the 8*8 block. Accordingly, the prediction mode corresponding to the smallest RDO is selected as the prediction mode for reconstructing the pixels in the 8*8 block. The prediction mode obtained here is more accurate than the prediction mode obtained in foregoing example for the factor of bit rate is considered.

After the prediction modes of the 8*8 blocks have been determined, the pixels in the 8*8 blocks are reconstructed based on the marginal pixels using the selected prediction modes (step S1040). The reconstruction process of the pixels in the 16*16 block is completed once the reconstruction values of the pixels in all the 8*8 blocks have been obtained. In the present embodiment, the 16*16 block is divided into four 8*8 blocks respectively denoted as 8*8 blocks I, II, III, and IV from top to bottom, left to right (as shown in FIG. 12(a)), and these 8*8 blocks are reconstructed in the order of: I→II, III→IV.

To increase the speed of foregoing pixel reconstruction process, in the present embodiment, the marginal pixel values of the 8*8 block are calculated first using the prediction formulas and then these marginal pixel values are used for the prediction of the neighbouring 8*8 block. As described above, the reconstruction work of the neighbouring 8*8 block can be carried out at the same time while the pixels in the current 8*8 block are being reconstructed, and accordingly the reconstruction time can be greatly reduced. The operation of carrying out the prediction and reconstruction at the same time is the same or similar to that described in the first embodiment, and therefore will not be described herein.

In the present embodiment, the prediction modes of all the 8*8 blocks in a 16*16 block are determined within one pass, which simplifies the original calculations over four 8*8 blocks under 9 prediction modes to calculations over only one 16*16 block under the 9 prediction modes and reduces the processing time for the intra frame prediction of the 8*8 blocks, thus, the efficiency of image processing is improved.

### The Third Embodiment

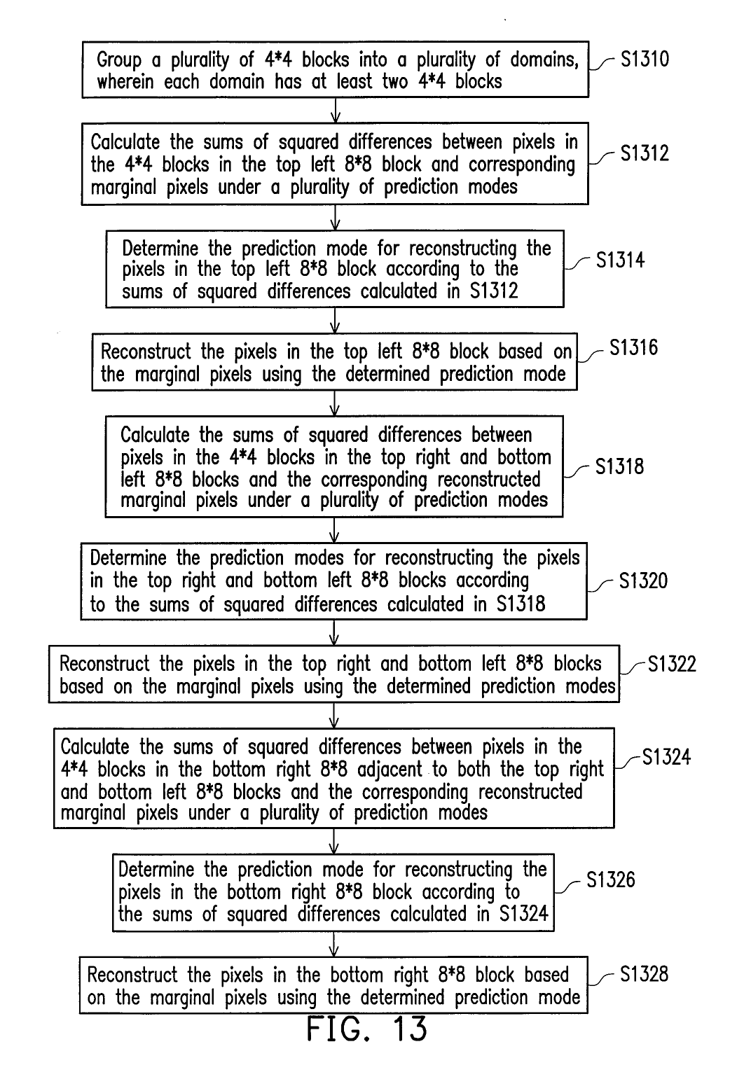

FIG. 13 is a flowchart illustrating an image processing method according to the third embodiment of the present invention. Referring to FIG. 13, the method in the present embodiment is suitable for processing an image which can be divided into a plurality of 4*4 blocks. First, these 4*4 blocks are grouped into a plurality of (for example, 4) domains, wherein each domain includes at least two of the 4*4 blocks (step S1310). Domains containing four 4*4 blocks (i.e. 8*8 blocks) will be described below as an example. In other words, a 16*16 block includes four 8*8 blocks respectively at top left, top right, bottom left, and bottom right, each 8*8 block includes four 4*4 blocks, and each 4*4 block includes 16 pixels. In the present embodiment, the original prediction formulas for a 4*4 block are expanded and applied to a 16*16 block, and the prediction modes of all the 8*8 blocks in the 16*16 block are determined within three passes, therefore the efficiency of image processing is improved.

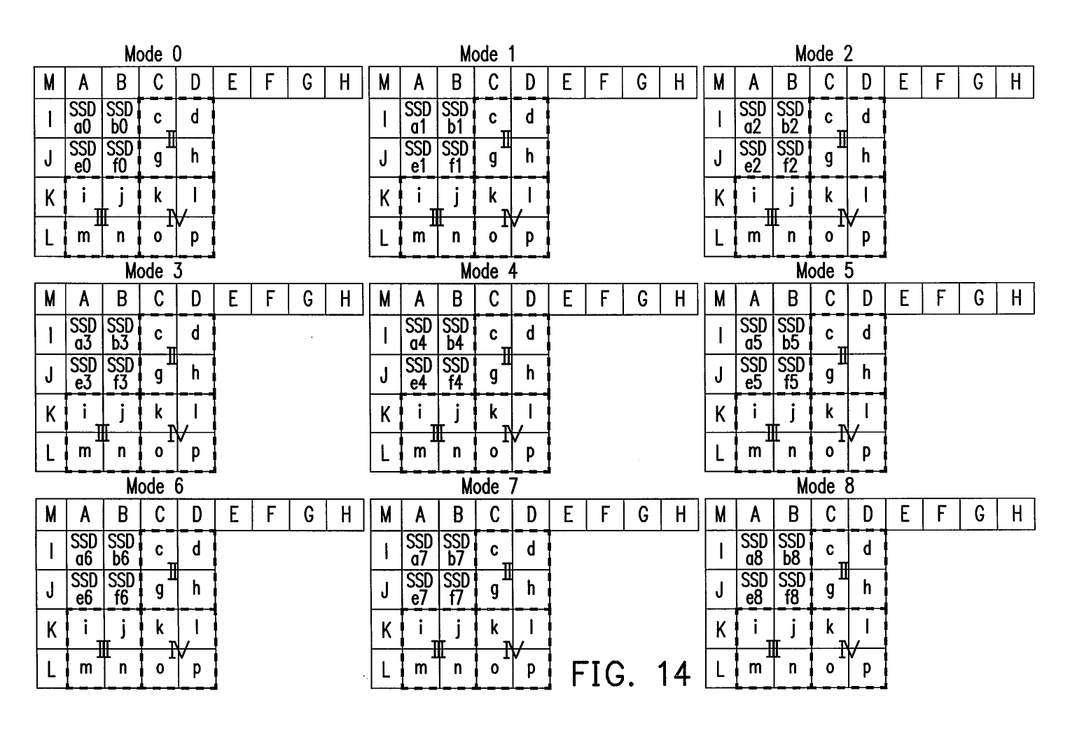

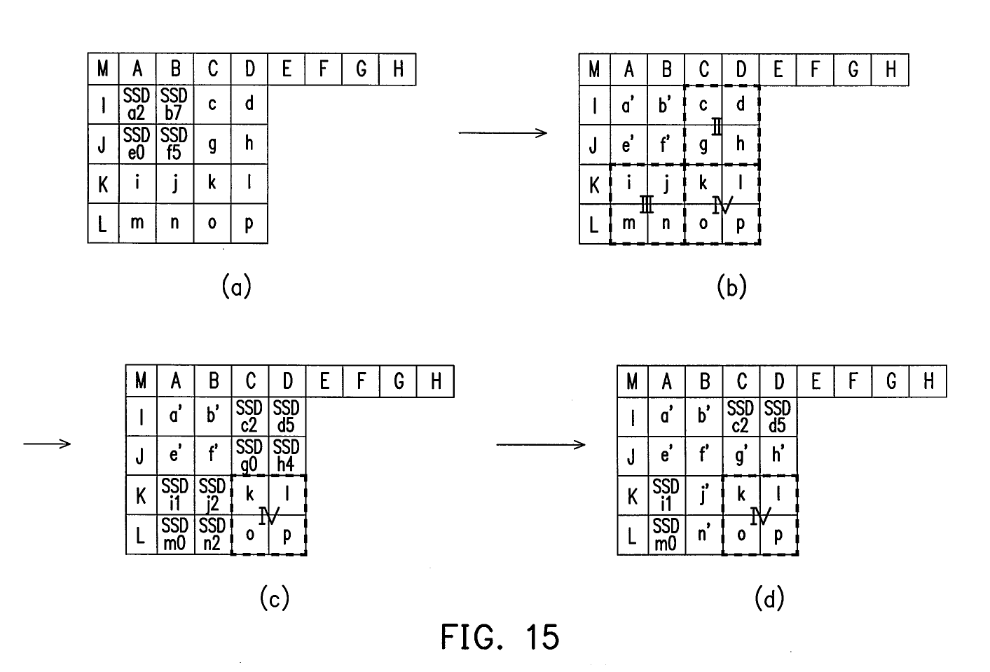

Similar to the first embodiment, the original prediction formulas of the 9 prediction modes of the intra frame prediction algorithm are expanded and applied to a 16*16 block in the present embodiment. However, different from the embodiment described above, only one of the 8*8 blocks (for example, the 8*8 block at the top left corner) is processed first in the present embodiment, and the sums of squared differences between the pixels in the 4*4 blocks in the 8*8 block and the corresponding marginal pixels under a plurality of prediction modes are calculated first (step S1312), wherein the obtained sums of are as listed in FIG. 14. The method for calculating of the sums of squared differences are the same or similar to that in foregoing embodiment, and therefore will not be described herein.

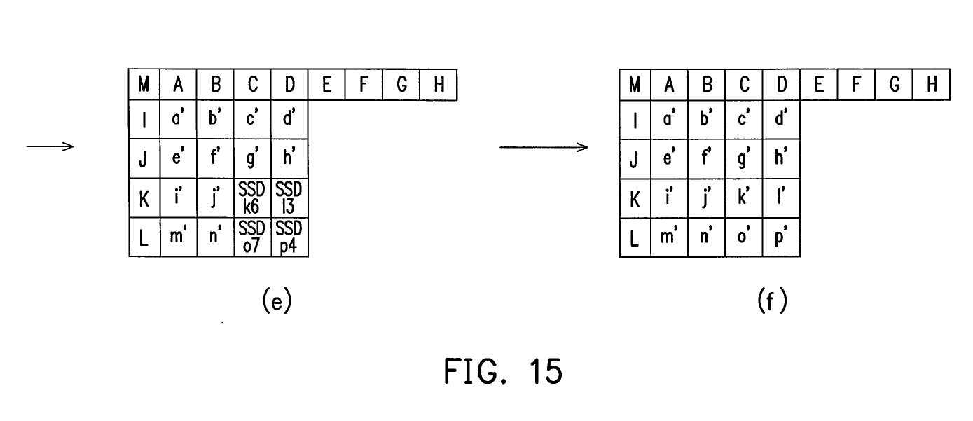

The most suitable prediction modes for the 4*4 blocks in the top left 8*8 block are determined according to the sums of squared differences obtained under the 9 prediction modes (step S1314). To be specific, in the present embodiment, the smallest value among the 9 sums of squared differences is respectively selected regarding each 4*4 block, and the prediction mode having the smallest value is selected as the most suitable prediction mode for this 4*4 block. FIG. 15 is a diagram illustrating an image processing method according to the third embodiment of the present invention. As shown in FIG. 15(a), the prediction mode selected for block a is the 2^{nd} prediction mode, the prediction mode selected for block b is the 7^{th} prediction mode, and so on.

After the prediction modes of the 4*4 blocks have been determined, the pixels in the 4*4 blocks in the top left 8*8 block are reconstructed based on the marginal pixels according to these prediction modes, and the reconstruction process of the top left 8*8 block is completed once the reconstruction values of the pixels in all the 4*4 blocks have been obtained (step S1316). Foregoing steps can be completed within one pass, thus, the time and resources for determining the prediction modes and calculating the reconstruction values of the pixels in the 4*4 blocks are both reduced.

Referring to FIG. 15(b), the reconstructed values of the 4*4 blocks a, b, c, and d have been calculated and reconstruction value arrays a′, b′, c′, and d′ are obtained. In an embodiment of the present invention, the foregoing process of calculating the reconstruction values of the pixels can be further divided into two steps, which includes calculating the prediction values of the pixels in the 4*4 blocks using the prediction formulas of the corresponding prediction modes of the 4*4 blocks, and adding the prediction values to the residuals of the pixels to obtain the reconstruction values of the pixels.

The pixels in the left 4*4 block of the top right 8*8 block and the pixels in the top 4*4 block of the bottom left 8*8 block become available once the reconstruction values of the pixels in the top left 8*8 block are obtained. Accordingly, next, the sums of squared differences between the pixels in the 4*4 blocks in the top right 8*8 block and the bottom left 8*8 block and the corresponding marginal pixels under the 9 prediction modes are respectively calculated (step S1318). The prediction modes for reconstructing the pixels in the top right and bottom left 8*8 blocks are then determined according to the sums of squared differences obtained in step S1318 (step S1320). Finally, the pixels in the top right and bottom left 8*8 blocks are reconstructed based on the marginal pixels according to the prediction modes determined in step S1320. Referring to FIG. 15(c), the sums of squared differences and prediction modes of the 4*4 blocks c, d, g, and h and the 4*4 blocks i, j, m, and n have all been determined. Referring to FIG. 15(d), the reconstruction values of the pixels in the 4*4 blocks g and h and the 4*4 blocks j and n have all been completed, and accordingly the reconstruction arrays g′, h′, j′, and n′ are obtained.

It should be mentioned here that the pixels in the blocks above or to the left of the bottom right 8*8 block become available once the prediction values of the pixels in the top right 8*8 block and the bottom left 8*8 block have been calculated using the prediction formulas. Thus, next, the sums of squared differences between the pixels in the 4*4 blocks in the bottom right 8*8 block and the corresponding reconstructed marginal pixels are calculated under the 9 prediction modes (step S1324). The prediction modes for reconstructing the pixels in the bottom right 8*8 block are determined according to the sums of squared differences obtained in step S1324 (step S1326) (as shown in FIG. 15(e)). Finally, the pixels in the bottom right 8*8 block are reconstructed according to the selected prediction modes based on the marginal pixels (step S1328). Accordingly, the reconstruction values of the pixels in all the 8*8 blocks in the 16*16 block are obtained (as shown in FIG. 15(f)), thus, the reconstruction of the pixels in the entire 16*16 block has been completed.

In the present embodiment, the prediction modes of all the 8*8 blocks in a 16*16 block are determined within three passes, which simplifies the calculations over sixteen 4*4 blocks under the 9 prediction modes to calculations over four 8*8 blocks under the 9 prediction modes and reduces the processing time of the intra frame prediction for the 4*4 blocks, thus, the efficiency of image processing is improved.

In summary, the image processing method in the present invention has at least following advantages:

1. the prediction modes of all the 4*4 or 8*8 blocks in a 16*16 block are determined within one pass so that it is not necessary to predict all the 4*4 blocks or 8*8 blocks one by one, thus, the calculation time is reduced and the efficiency of image processing is improved.

2. the prediction modes of the 8*8 blocks at the top left, top right, bottom left, and bottom right are respectively determined within three passes, so that it is not necessary to predict all the 4*4 blocks one by one, thus, the calculation time is reduced and the efficiency of image processing is improved.

3. subsequent DCT, quantization, and entropy calculations can be performed to a current block after the prediction mode of this block has been determined and while other blocks are being predicted, thus, the calculation time is reduced and the efficiency of image processing is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image processing method, suitable for processing an image which is divided into a plurality of prediction blocks, comprising:
a. calculating the sums of squared differences between pixels in the prediction blocks and corresponding marginal pixels under a plurality of prediction modes;
b. determining the prediction modes for reconstructing the pixels in the prediction blocks according to the result of step a; and
c. reconstructing the pixels in the prediction blocks according to the result of step b.

2. The image processing method according to claim 1, after step a, further comprising:
a1. calculating residuals of the pixels in the prediction blocks under the prediction modes using the result of step a; and
a2. determining the prediction modes for reconstructing the pixels in the prediction blocks according to the results of steps a and a1.

3. The image processing method according to claim 1, wherein the image is a block comprising 16*16 pixels.

4. The image processing method according to claim 3, wherein the prediction blocks are 4*4 blocks.

5. The image processing method according to claim 1, wherein the marginal pixels are pixels of a column/row matrix.

6. The image processing method according to claim 1 comprising 9 prediction modes.

7. The image processing method according to claim 6, wherein the prediction modes comprise a vertical prediction mode, a horizontal prediction mode, a DC prediction mode, a diagonal down-left prediction mode, a diagonal down-right prediction mode, a vertical right prediction mode, a horizontal down prediction mode, a vertical left prediction mode, and a horizontal up prediction mode.

8. The image processing method according to claim 2, wherein the residuals of the pixels in the prediction blocks under the prediction modes in step a1 is the differences between the pixels in the prediction blocks and the corresponding marginal pixels under the prediction modes.

9. The image processing method according to claim 2, wherein step a2 further comprises:
a2-1. determining the corresponding bit rates of the pixels in the prediction blocks under the prediction modes according to the result of step a1;
a2-2. calculating the rate-distortion optimizations (RDOs) of the pixels in the prediction blocks according to the results of steps a and a2-1; and
a2-3. determining the prediction modes for reconstructing the pixels in the prediction blocks according to the result of step a2-2.

10. The image processing method according to claim 9, wherein in step a2-1, the corresponding bit rates of the pixels in the prediction blocks under the prediction modes are determined by performing a discrete cosine transformation (DCT), a quantization, and an entropy calculation to the residuals of the pixels in the prediction blocks under the prediction modes.

11. The image processing method according to claim 1, wherein in step c, the pixels in the prediction blocks are reconstructed based on the marginal pixels according to the prediction modes determined by the prediction blocks.

12. The image processing method according to claim 4, wherein the 16 prediction blocks are respectively denoted as prediction blocks a˜p from top to bottom, left to right, and in step c, the prediction blocks are reconstructed in the order of: a→b, e→c, f, i→d, g, j, m→h, k, n→l, o→p.

13. An image processing method, suitable for processing an image which is divided into a plurality of prediction blocks, comprising:
a. dividing the prediction blocks into a plurality of domains, wherein each of the domains comprises at least two of the prediction blocks;
b. regarding one of the domains, calculating the sums of squared differences between pixels in the prediction blocks in the domain and corresponding marginal pixels;
c. determining the prediction modes for reconstructing the pixels in the prediction blocks in the domain according to the result of step b;
d. reconstructing the pixels in the prediction blocks in the domain according to the result of step c; and
e. reconstructing pixels in the prediction blocks in a neighboring domain using the reconstructed marginal pixels of the domain according to the result of step d.

14. The image processing method according to claim 13, after step b, further comprising:
b1. calculating residuals of the pixels in the prediction blocks in the domain using the result of step b; and
b2. determining the prediction modes for reconstructing the pixels in the prediction blocks in the domain according to the results of steps b and b1.

15. The image processing method according to claim 13, wherein the image is a block comprising 16*16 pixels.

16. The image processing method according to claim 15, wherein the prediction blocks are 4*4 blocks.

17. The image processing method according to claim 16, wherein the domains are 8*8 blocks.

18. The image processing method according to claim 13, wherein the marginal pixels are pixels of a column/row matrix.

19. The image processing method according to claim 13 comprising 9 prediction modes.

20. The image processing method according to claim 19, wherein the prediction modes comprise a vertical prediction mode, a horizontal prediction mode, a DC prediction mode, a diagonal down-left prediction mode, a diagonal down-right prediction mode, a vertical right prediction mode, a horizontal down prediction mode, a vertical left prediction mode, and a horizontal up prediction mode.

21. The image processing method according to claim 14, wherein the residuals of the pixels in the prediction blocks under the prediction modes in step b1 is the differences between the pixels in the prediction blocks in the domain and the corresponding marginal pixels under the prediction modes.

22. The image processing method according to claim 14, wherein step b2 further comprises:
b2-1. determining the corresponding bit rates of the pixels in the prediction blocks in the domain under the prediction modes according to the result of step b1;
b2-2. calculating the RDOs of the pixels in the prediction blocks in the domain according to the results of steps b and b2-1; and
b2-3. determining the prediction modes for reconstructing the pixels in the prediction blocks in the domain according to the result of step b2-2.

23. The image processing method according to claim 22, wherein in step b2-1, the corresponding bit rates of the pixels in the prediction blocks in the domain under the prediction modes are determined by performing a DCT, a quantization, and an entropy calculation to the residuals of the pixels in the prediction blocks in the domain under the prediction modes.

24. The image processing method according to claim 13, wherein in step e, the pixels in the prediction blocks in the domain are reconstructed based on the marginal pixels according to the prediction modes determined by the prediction blocks in the domain.

25. The image processing method according to claim 16, wherein the 4 prediction blocks are respectively denoted as prediction blocks a, b, e, and f from top to bottom, left to right, and in step e, the prediction blocks are reconstructed in the order of: a→b, e→f.

26. The image processing method according to claim 13, wherein step e further comprises:
e1. calculating the sums of squared differences between pixels in the prediction blocks in at least one neighboring domain and corresponding reconstructed marginal pixels in the domain under the plurality of prediction modes;
e2. calculating residuals of the pixels in the prediction blocks in the neighboring domain under the prediction modes using the result of step e1;
e3. determining the prediction modes for reconstructing the pixels in the prediction blocks in the neighboring domain according to the results of steps e1 and e2; and
e4. reconstructing the pixels in the prediction blocks in the neighboring domain according to the result of step e3.

27. The image processing method according to claim 26, wherein steps e1˜e4 are to reconstruct the pixels in the two neighboring domains.

28. The image processing method according to claim 27 further comprising:
f. reconstructing pixels in a neighboring domain adjacent to both the two neighboring domains using the reconstructed pixels in the two neighboring domains according to the result of step e4.

29. The image processing method according to claim 13, wherein step f further comprises:
f1. calculating the sums of squared differences between the pixels in the prediction blocks in the domain and the corresponding reconstructed marginal pixels in the two neighboring domains under the plurality of prediction modes;
f2. calculating residuals of the pixels in the prediction blocks in the domain under the prediction modes using the result of step f1;
f3. determining the prediction modes for reconstructing the pixels in the prediction blocks in the domain according to the results of steps f1 and f2; and
f4. reconstructing the pixels in the prediction blocks in the domain according to the result of step f3.

30. An image processing method, suitable for processing an image which is divided into a plurality of prediction blocks, comprising:
a. dividing the prediction blocks into a plurality of domains, wherein each domain comprises at least two of the prediction blocks;
b. calculating the sums of squared differences between pixels in the prediction blocks in each of the domains and corresponding marginal pixels under a plurality of prediction modes;
c. determining the prediction modes for reconstructing the pixels in the prediction blocks in each of the domains according to the result of step b; and
d. reconstructing the pixels in the prediction blocks in each of the domains according to the result of step c.

31. The image processing method according to claim 30, after step b, further comprising:
b1. calculating residuals of the pixels in the prediction blocks in each of the domains under the prediction modes according to the result of step b; and
b2. determining the prediction modes for reconstructing the pixels in the prediction blocks in each of the domains according to the results of steps b and b1.

32. The image processing method according to claim 30, wherein the image is a block comprising 16*16 pixels.

33. The image processing method according to claim 30, wherein the prediction blocks are 4*4 blocks.

34. The image processing method according to claim 30, wherein the domains are 8*8 blocks.

35. The image processing method according to claim 30, wherein the marginal pixels are pixels of a column/row matrix.

36. The image processing method according to claim 30 comprising 9 prediction modes.

37. The image processing method according to claim 36, wherein the prediction modes comprise a vertical prediction mode, a horizontal prediction mode, a DC prediction mode, a diagonal down-left prediction mode, a diagonal down-right prediction mode, a vertical right prediction mode, a horizontal down prediction mode, a vertical left prediction mode, and a horizontal up prediction mode.

38. The image processing method according to claim 31, wherein step b1 is to calculate the differences between the pixels in the prediction blocks in each of the domains and the corresponding marginal pixels under the prediction modes.

39. The image processing method according to claim 31, wherein step b2 further comprises:
b2-1. determining the corresponding bit rates of the pixels in the prediction blocks in each of the domains under the prediction modes according to the result of step b-1;
b2-2. calculating the RDOs of the pixels in the prediction blocks in each of the domains according to the results of steps b and b2-1; and
b2-3. determining the prediction modes for reconstructing the pixels in the prediction blocks in each of the domains according to the result of step b2-2.

40. The image processing method according to claim 39, wherein in step b2-1, the corresponding bit rates of the pixels in the prediction blocks in each of the domains under the prediction modes are determined by performing a DCT, a quantization, and an entropy calculation to the residuals of the pixels in the prediction blocks in each of the domains under the prediction modes.

41. The image processing method according to claim 30, wherein in step d, the pixels in the prediction blocks in each of the domains are reconstructed based on the marginal pixels according to the prediction modes determined by the prediction blocks in each of the domains.

42. The image processing method according to claim 33, wherein the 4 domains are respectively denoted as domains I, II, III, and IV from top to bottom, left to right, and in step e, the prediction blocks are reconstructed in the order of: I→II, III→IV.
